(19) United States
(12) Patent Application Publication
(10) Pub. No.: US 2010/0044988 A1
(43) Pub. Date: Feb. 25, 2010

(54) Integrated Swaybar and Torque Rod Suspension Link

(75) Inventors: Ryan Rochester, Fort Wayne, IN (US); James Merriman, Fort Wayne, IN (US)

Correspondence Address: International Truck Intellectual Property Company,, 4201 WINFIELD ROAD, WARRENVILLE, IL, 60555, US

(73) Assignee: International Truck Intellectual Property Company LLC, Warrenville, IL (US)

(21) Appl. No.: 12/194,978

(22) Filed: Aug. 20, 2008

(51) Int. Cl. B60G 11/64; B60G 21/055

(52) U.S. Cl. 280/124.116

(57) ABSTRACT

A suspension link for an axle of a motor vehicle includes first and second arms, with the first and second arms being laterally spaced and substantially parallel. A first end of each arm is coupled to the axle by a bushing. A second end of each arm is coupled to a motor vehicle frame by a frame bushing. A sway bar is rigidly mounted between the first and second arms substantially distal to the first ends of the first and second arms, proximate to the second ends and parallel to the axle.

### BACKGROUND

1. Technical Field

The invention relates to motor vehicle suspensions, and more particularly to an integrated sway bar and torque rod.

2. Description of the Problem

Sway bars and torque rods are well known suspension system elements. Torque rods (or torque arms) have been used to absorb torque generated by an axle, and have been common on rear drive axles to absorb some of the torque generated by a rear drive axle during acceleration. Torque rods have also been used to absorb braking torque from front steering axles in heavy duty truck applications. Sway bars (also known as stabilizer bars) are shafts which connect lower suspension arms from side to side on vehicles in order to reduce vehicle body roll during cornering. This allows the use of less stiff springs than might otherwise be used to produce a “softer” ride for passengers. Employment of these elements in motor vehicle suspensions has entailed the use of multiple components which have added to the weight of the vehicles and to the expense of manufacturing the vehicles.

Previous examples of combining motor vehicle suspension sway bars and torque rods exist. For example, U.S. Pat. No. 5,549,320 teaches a suspension assembly for a rear axle including a combined sway bar and torque rods. The sway bar is implemented as a cross member connecting two parallel arms. The arms are pivotally connected at an end to each end of the cross member. The free ends of the arm are attached to the axle positioning the cross member parallel to and spaced from the axle. Simplification in assembly was achieved by reducing the number of required attachment points to the vehicle frame. The '320 patent further claimed less restriction on axle cross articulation, improving vehicle traction and minimizing stress on linkages and the bracket used to attach the linkages to the vehicle frame.

The integration of the sway bar and a set of torque rods and fitting of the combined suspension element into a suspension system can be further optimized in terms of suspension system geometry for weight savings, assembly cost and packaging. This requires consideration of linkages that can be displaced by the assembly.

### SUMMARY

An integrated sway bar and torque rod suspension link, particularly suited for a truck front steering axle is provided. The suspension link includes first and second parallel torque arms. A cross member element is rigidly mounted between the first and second torque arms by welding, holding the torque arms in parallel relationship. Bushings are provided at each end of the torque arms providing for coupling the suspension link between a motor vehicle frame (or more precisely hangers depending from frame rails) and the axle at four points, two on the frame and two on the axle. The bushings provide two parallel axes of rotation transverse to the direction of travel of the vehicle.

Additional effects, features and advantages will be apparent in the written description that follows.

### BRIEF DESCRIPTION OF THE DRAWINGS

The contribution to the art believed novel is set forth in the appended claims. The preferred mode of use will best be understood by reference to the following detailed description of an illustrative embodiment when read in conjunction with the accompanying drawings, wherein:

FIG. 1 is a perspective view of the integrated sway bar and torque rod suspension link.

FIG. 2 is a perspective view of the suspension link as applied to a front steering axle suspension.

FIG. 3 is a reverse angle perspective view of the suspension link as applied to a front steering axle suspension.

### DETAILED DESCRIPTION OF THE INVENTION

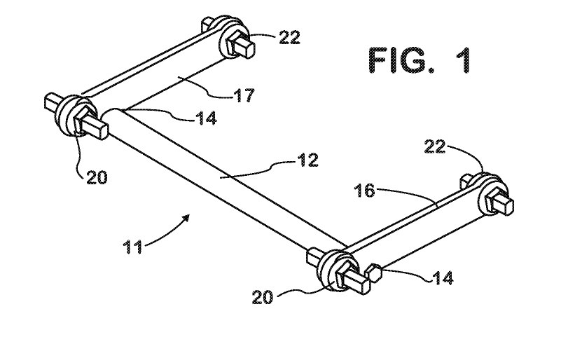

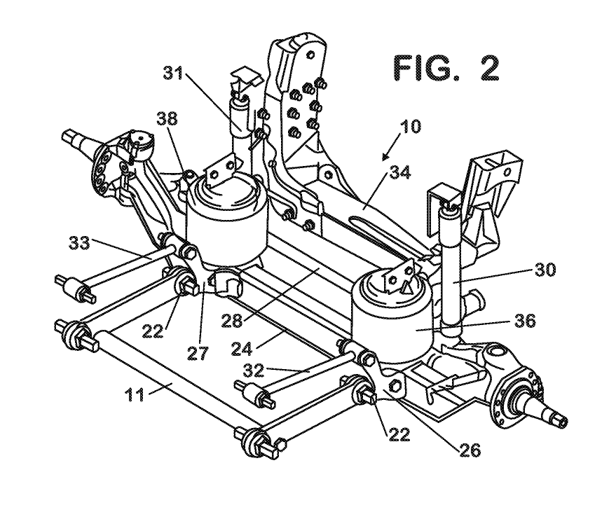

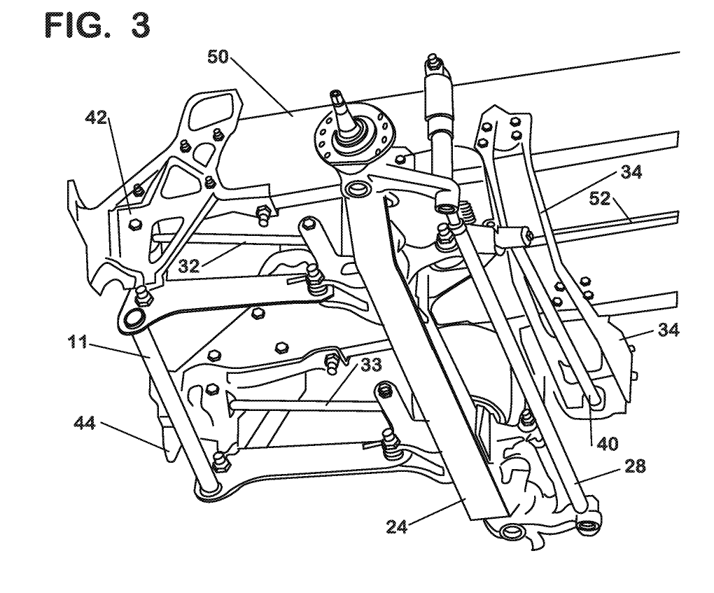

Referring now to the drawings and in particular to FIG. 1, an integrated sway bar and torque rod suspension link 11 is illustrated. Suspension link 11 includes a sway bar 12 which, upon installation of the suspension link 11 on a vehicle, runs transverse to the direction of elongation of a vehicle frame (shown in FIGS. 2 and 3). Sway bar 12 is joined to first and second torque arms 16/17 along welded joints 14. The joints 14 are located on the torque arms distal to the points of connection of the arms to an axle. Torque arms 16 and 17 are kept in parallel by the sway bar 12. Torque arms 16/17 terminate in frame bushings 20 and axle bushings 22. Frame bushings 20 provide for pivoting attachment of the suspension link 11 to the vehicle frame (shown in FIG. 3) and axle bushings 22 provide for pivoting attachment of the suspension link 11 to a front steering axle of a truck. Bushings 20 and 22 provide suspension link 11 with two axes of rotation, one through bushings 20 and the second through bushings 22. The axes of rotation are in parallel with one another and the steering axle. The integrated sway bar 11 consists of the integrated torque arms and sway bar element and four attachment bushings, a total of five pieces.

The suspension link 11 of FIG. 1 is illustrated in FIGS. 2 and 3 as connected to a front steering axle 24 as a part of a five link front axle suspension system 10. Steering axle 24 is held transverse to a vehicle frame (shown in FIG. 3) and parallel to a frame cross member 34 by the five link suspension. Attached to the axle 24 near the ends thereof are first and second axle brackets and spring seats 26 and 27. Air springs 36 and 38 are installed on top of the axle bracket and spring seats 26, 27, respectively, with the frame rails 50 and 52 being supported on top of the springs. Shock absorbers 30 and 31 are pivotally connected at their bottom linkages to the axle 24. The suspension link 11 is attached as a trailing element by axle bushings 22 to the axle brackets 26 and 27. Further connected to the axle brackets 26 and 27 are trailing torque rods 32, 33. Additional suspension linkages may be used in a leading arrangement relative to the axle.

Hanger brackets 42 and 44 depend from frame rails 50, 52 forward from steering axle 24 to provide connection points for linkage element 11 and torque rods 32 and 33. A transverse torque rod 40 is located rearward from steering axle 24 and is connected between the steering axle and a frame cross member 34, which is located behind the axle and under the frame rails 50, 52.

While only a preferred embodiment is described here in detail, the claims are not limited thereto, but are intended to extend to various changes and modifications thereof.

What is claimed is:

1. A suspension link for an axle of a motor vehicle, the suspension assembly comprising:
first and second arms, the first and second arms being laterally spaced and substantially parallel, a first end of each arm being coupled to the axle by first and second axle bushings;
a second end of each arm being coupled to a motor vehicle frame by first and second frame bushings; and
a sway bar rigidly mounted between the first and second arms substantially distal to the first ends of the first and second arms, proximate to the second ends and parallel to the axle.

2. A suspension link as claimed in claim 1, the axle being a front steering axle.

3. A suspension link as claimed in claim 2, the suspension link being attached between the motor vehicle frame and the front steering axle as a trailing link.

4. A suspension link as claimed in claim 3, further comprising welded joints between the sway bar and the first and second arms.

5. A motor vehicle frame, suspension and wheel positioning assembly comprising:
first and second frame rails;
a hanger depending from each of the first and second frame rails;
an axle;
first and second arms, the first and second arms being laterally spaced and substantially parallel, a first end of each arm being coupled to the axle by first and second axle bushings and a second end of each arm being coupled to the hangers depending from the first and second frame rails by first and second frame bushings; and
a sway bar rigidly mounted between the first and second arms substantially distal to the first ends of the first and second arms, proximate to the second ends and parallel to the axle.

6. An assembly as claimed in claim 5, the axle being a front steering axle.

7. An assembly as claimed in claim 6, the first and second arms being attached between the hangers and the front steering axle as trailing links.

8. An assembly as claimed in claim 7, further comprising welded joints between the sway bar and the first and second arms.

9. An assembly as claimed in claim 8, further comprising air springs positioned at opposite ends of the front steering axle and supporting the first and second frame rails from the steering axle.

10. An assembly as claimed in claim 9, further comprising first and second torque rods attached as trailing links between the hangers and the front steering axle substantially parallel to the first and second arms.

11. An assembly as claimed in claim 10, further comprising a longitudinal torque rod connected between the front steering axle and one of the first or second frame rails.
